(19) United States
(12) Patent Application Publication
(10) Pub. No.: US 2026/0295893 A1
(43) Pub. Date: Oct. 1, 2026

(54) Sawing Grip Assembly

(71) Applicant: Nikolai Ugrinsky, Charlotte, NC (US)

(72) Inventor: Nikolai Ugrinsky, Charlotte, NC (US)

(21) Appl. No.: 19/631,228

(22) Filed: Mar. 27, 2026

Related U.S. Application Data
(60) Provisional application No. 63/781,549, filed on Apr. 1, 2025.

(51) Int. Cl. B27G 5/02; B27B 21/00

(52) U.S. Cl. CPC B27G 5/026; B27B 21/00

(57) ABSTRACT

A miniature sawing buck comprised of two profiles, connected by a bar, and resting on a horizontal surface, allowing a variety of work on manually held workpieces that are extending to either end of the assembly and are elevated above the horizontal surface or utilizing the miter box guide openings provided in one of the two profiles for sawing the workpieces at predefined angles.

### 2) CROSS-REFERENCE TO RELATED APPLICATIONS

Provisional Patent Application No. 63/781,549.

Filing Date: Apr. 1, 2025.

Confirmation Number: 1820.

### 3) BACKGROUND OF THE INVENTION

Craftsmen, hobbyists, carpenters, woodworkers, and DYI home owners often face a situation where they need to work on elongated workpieces like floor boards, trims, moldings, quarter rounds, etc. for their projects. In these cases, the workpiece needs to be affixed to a workbench, table top, or other working surface by means of a clamp, or held by a vise, as holding it only by hand is very difficult and could not only result in the waste of the workpiece, as this method doesn't provide the proper execution of the process one wants to perform, but also in injuries as the workpiece moves around and tools might get too close to the holding hand. Often the affixation itself could damage the workpiece, if a clamp or vise is tightened to strongly.

The same is true when trying to make angular cuts for baseboards and picture frames, where a 45 or 22.5 degree cut is desired. When performed manually, one could utilize a miter box, but the affixation of the workpiece within the box is needed, and holding the piece by hand is not easily accomplished and often dangerous as the hand and the saw's blade get very close to each other.

### 4) BRIEF SUMMARY OF THE INVENTION

The sawing grip assembly provides a method to hold an elongated workpiece in place for cutting, sanding, painting, and other processes and allows for precise execution without the use of a vice, clamp, or other means of affixation. One places the workpiece onto the sawing grip assembly and holds it with one hand and works on it with the other hand. Due to its form, which resembles in essence a miniature sawbuck, the manual affixation does not require much force and can be executed by an adult or older child, right or left handed. It is suitable for a variety shapes and materials of smaller elongated workpieces and can be mounted on a table top, counter top, work bench, or floor. These features are usually not provided by a regular larger sawbuck that is built for cutting firewood from tree trunks and branches. It further allows the execution of angular cuts similar to that of a miter box by using the angular openings in one of the profiles.

### 5) BRIEF DESCRIPTION OF DRAWINGS

FIG. 1 shows a perspective view of the sawing grip assembly, which is based on the principal of a sawbuck, and utilizes two L-shaped profiles 1 and 2 that are mounted on and connected by an inverted trapezoid-shaped connection bar 3 that fits into the lower bottom part of the profile and allows the L-shaped profiles to be moved freely along the connection bar, but are unable to be pulled off vertically due to the bar's inverted trapezoid shape. The sawing grip assembly then rests on a horizontal working surface 4 like a table top or work bench and the profiles'vertical extension 5 aligns with the horizontal surface's edge. The sawing grip assembly is agnostic to which hand the user prefers to use for executing the process vs. holding the workpiece in place, as it is symmetrical and the profiles 1 and 2 can be inserted onto the connection bar 3 on either side. The wider profile 2 houses vertical openings 12 in the vertical blocking surface 8. The openings end above the tilted horizontal landing surface 7 that serve as guides to allow performing angular cuts by inserting a sawing blade like one would do for picture frames and the likes.

FIG. 2 shows how the shape of the profiles 1 and 2 allow for long-shaped workpieces 6 made of wood, metal, or plastic, like rods, trims, and moldings to rest in the center of the profile onto a tilted horizontal landing surface 7 and against a vertical blocking surface 8 provided by both profiles.

FIG. 3 demonstrates how the workpiece 6 can then be worked on by one hand performing sawing, sanding, cutting, or painting or other processes on the workpiece. At the same time, the other hand provides the necessary force to keep the workpiece in place during these processes. The L-shaped profile 1 closest to the workpiece separates the hand supporting the workpiece from the tool working on it, thus preventing injuries and providing safety for the user.

FIG. 4 shows a cross section of profile 1 and is taken on the line 4-4 of FIG. 9.

FIG. 5 shows the side view of profile 1.

FIG. 6 shows a cross section of profile 1 and is taken on the line 6-6 of FIG. 5.

FIG. 7 shows the front view of profile 1.

FIG. 8 shows the bottom view of profile 1.

FIG. 9 shows the top view of profile 1.

This sheet and its views and cross sections are illustrating the support structure for the tilted horizontal landing surface 7 and the vertical blocking surface 8. The underside of the profile is hollow and the sidewalls 10 and support walls 11 around the underside opening for the connection bar provide the essential stability to the profile 1. The extension wall 9 is to prevent the assembly from sliding across the horizontal work surfaces.

FIG. 10 shows the front view of the wider profile 2.

FIG. 11 shows the side view of profile 2.

FIG. 12 shows a cross section and is taken on the line 12-12 of FIG. 13.

FIG. 13 shows the top view of profile 2.

FIG. 14 shows the bottom view of profile 2.

FIG. 15 shows a cross section of the wider profile 2 and is taken on the line 15-15 of FIG. 11.

This sheet and its cross sections are illustrating the support structure for the tilted horizontal landing surface 7 and the vertical blocking surface 8. The underside of the profile is hollow. The sidewalls 10, the support walls 13 for the openings 12 in the vertical part of the profile, and the surrounding walls 11 around the opening for the connection bar provide the essential stability to the profile. The extension wall 9 is to prevent the assembly from sliding across the horizontal work surfaces.

FIG. 16 shows a top view of the trapezoidal connection bar.

There are two openings 14 for the affixation of the bar onto a work surface using countersunk screws or other fasteners if desired. There is one larger opening 15 providing means to hang the complete sawing grip assembly onto a hock commonly found at a store's display wall of selling items.

FIG. 17 shows a cross section taken on the line 17-17 of FIG. 16.

FIG. 18 shows a bottom view of the connection bar.

The underside of the bar is hollow with supporting trusses 16 for the side walls.

FIG. 19 shows the side view of the connection bar.

FIG. 20 shows a cross section taken on line 20-20 of FIG. 16.

FIG. 21 shows the sawing grip assembly including both profiles 1 and 2 and connection bar 3, assembled and mounted on a work surface and its edge in a front view.

FIG. 22 shows a side view of the assembly, cross-sectioning through the working surface in a side view.

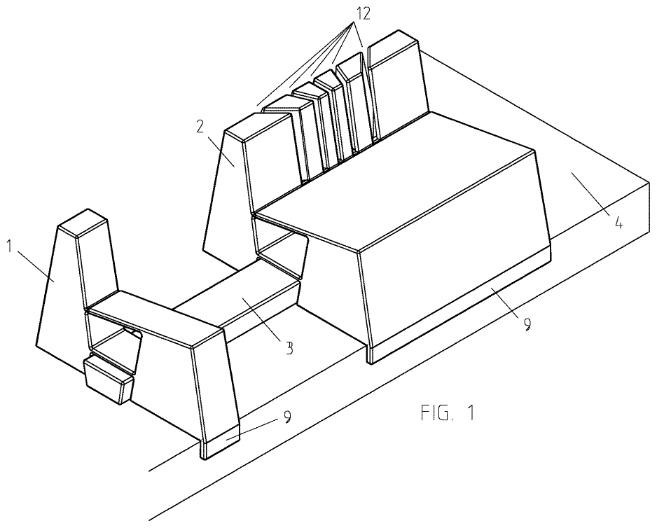

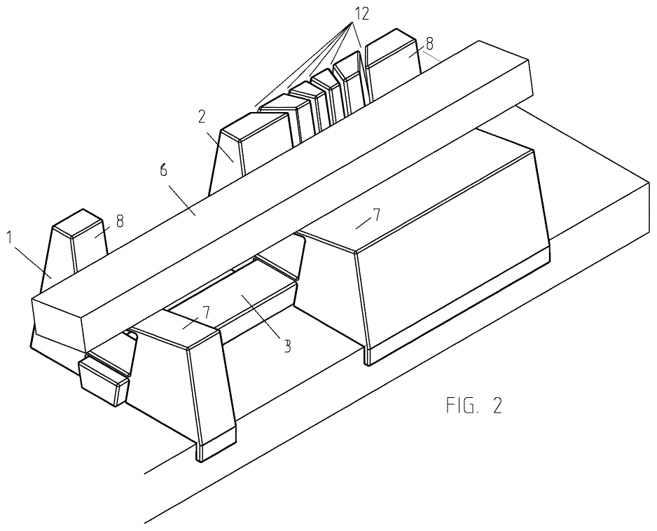

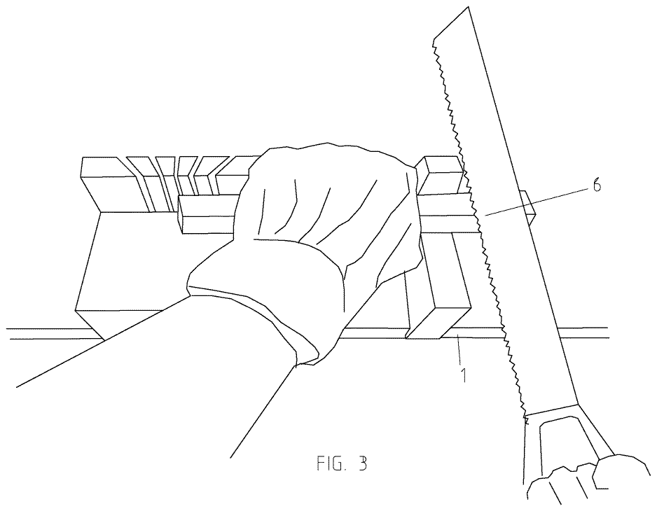

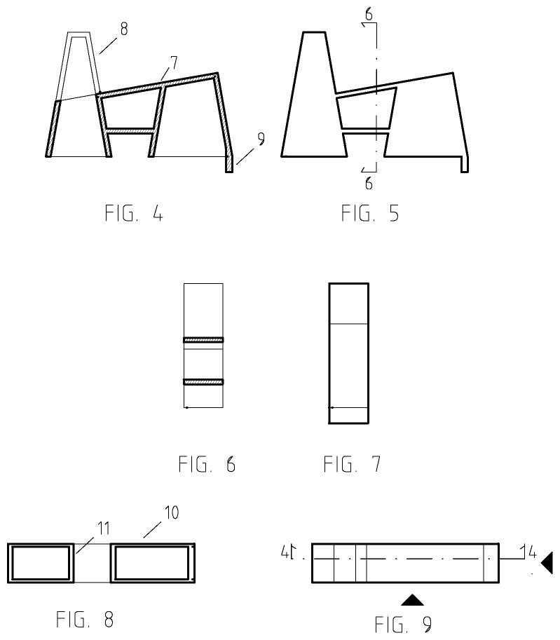

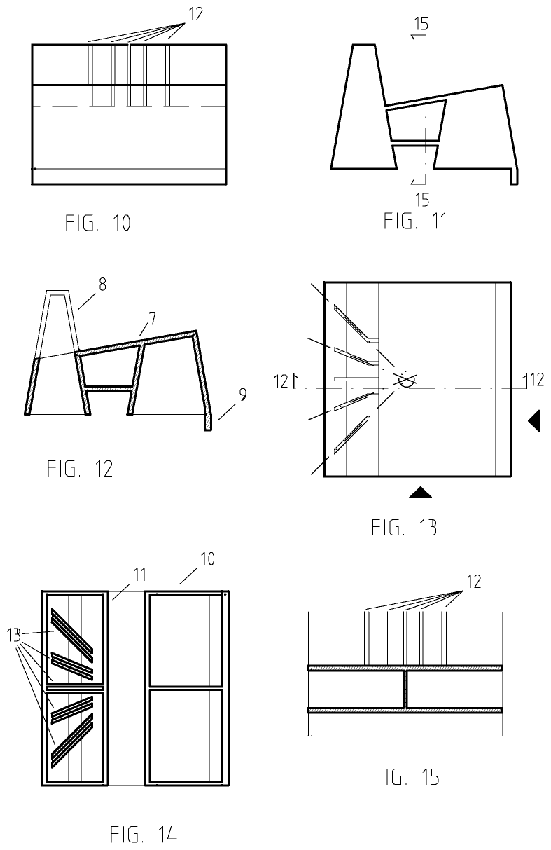

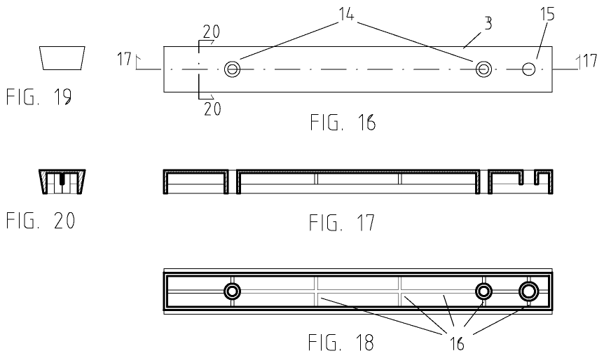

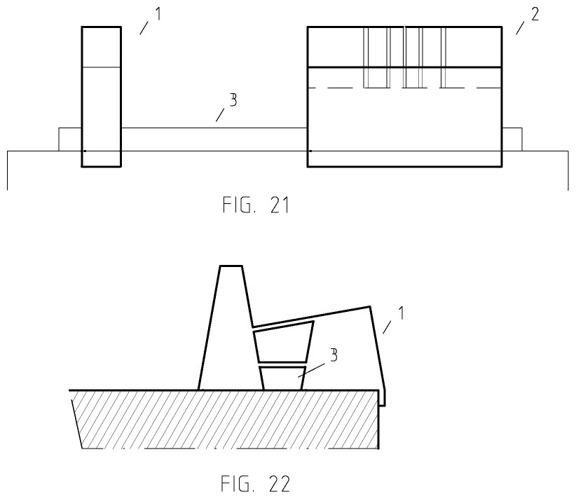

### 6) DETAILED DESCRIPTION OF INVENTION

1. The invention relates to working on handheld elongated workpieces of different cross sections and materials. There is provided a means of holding workpieces in place by two L-shaped profiles and the assembly of these profiles through a connection bar. Once placed onto the profiles the workpiece is then held in place by pushing it onto the profiles by manual force, e.g. of the hand or foot. The sawing grip assembly resembles in essence a sawbuck, but due to its smaller size allows for working on much smaller workpieces than tree branches and trunks, and allows operating the assembly on a table top, counter top, or workbench. Oftentimes, holding a workpiece in place is done by using a vice, clamp, or other tools used for fixating the workpiece, but often these can damage the workpiece itself, or are not suitable for particular shapes and materials like PVC pipe, which is very slippery. These drawbacks can be avoided by using the sawing grip assembly. The elevation of the L-shaped profiles'allows for operating on workpieces directly above a work surface that do not require being fixated at the left or right edge of a working surface, which is common with other tools.
2. There is further provided a means of cutting elongated workpieces in particular angles, as one of the profiles contains vertical openings at predetermined angles. These are wide enough to allow a saw blade to be inserted above the workpiece and deep enough for executing accurate angled cuts for making picture frames or the like. The advantage of the invention here is that other tools, like miter boxes, do not provide appropriate means of holding the workpiece in place and therefore require the usage of clamps and other means of fixation. The L-shape of the wider profile housing these vertical openings removes the limitation of the width of the workpiece that standard two-sided miter boxes usually have.
3. The sawing grip assembly is reversible, meaning that the order of profiles on the connection bar can be changed, making it usable for right handed as well as left handed users. The force needed to hold a workpiece in place, supported by the user's own weight, is minimal.
4. The connection bar comprises of two openings that can be used to insert countersunk screws that can be fastened into the working surface if desired. The connection bar has another larger opening providing means to hang the complete sawing grip assembly onto a hock commonly found at a store's display wall of selling items.
5. The sawing grip assembly is built out of a rigid material like plastic or the like, and is brought into its particular shape by means of plastic injection molding or other forming manufacturing processes, like CNC.

I claim:

1. The sawing grip assembly comprising two profiles of equal cross section and an elongated connection bar.

2. The sawing grip assembly of claim 1 wherein said connection bar comprises of a trapezoidal cross section, with its larger side on top.

3. The sawing grip assembly of claim 2 wherein said connection bar comprises of two openings providing means for an affixation of said sawing grip assembly to a horizontal work surface.

4. The sawing grip assembly of claim 1 wherein each said profile provides a tilted horizontal landing surface and a tilted vertical blocking surface, with both said surfaces elevated above the said horizontal works surface by means of their underlying structure, allowing said profiles to carry an elongated workpiece of various sizes, shapes, and materials.

5. The sawing grip assembly of claim 4 wherein said profiles provide an opening on the underside of equal shape as said connection bar.

6. The sawing grip assembly of claim 4 wherein said profiles are separated from each other on said connection bar by a distance, allowing enough space for a hand, foot, or other means of manual force to fit in between said profiles.

7. The sawing grip assembly of claim 4 wherein both said profiles extend on the underside by an extension wall aligning perpendicular to the said horizontal work surface and parallel to the edge of said horizontal work surface.

8. The sawing grip assembly of claim 4 wherein one of said profiles is wider than the other said profile and houses multiple vertical openings in said vertical blocking surface in the form of slits at multiple angles that end above said horizontal landing surface, and provide means for the insertion of a sawing blade of a hand held manual or electrical saw.

9. The sawing grip assembly of claim 8 wherein said vertical openings in the form of slits are supported by adjacent walls on either side of said vertical openings.

10. The sawing grip assembly of claim 8 wherein said vertical openings in the form of slits are at angles of 0 degrees, and 22.5 and 45 degrees on either side of the 0 degree opening, measured at the center of said vertical opening in form of a slit.
